(19) United States
(12) Patent Application Publication
(10) Pub. No.: US 2026/0098610 A1
(43) Pub. Date: Apr. 9, 2026

(54) PRESSURE VESSEL

(71) Applicant: TOYOTA JIDOSHA KABUSHIKI KAISHA, Toyota-shi (JP)

(72) Inventor: Yuki KAI, Nagoya-shi (JP)

(73) Assignee: TOYOTA JIDOSHA KABUSHIKI KAISHA, Toyota-shi (JP)

(21) Appl. No.: 19/341,442

(22) Filed: Sep. 26, 2025

(30) Foreign Application Priority Data
Oct. 8, 2024 (JP) 2024-176680

(51) Int. Cl. F17C 1/06

(52) U.S. Cl. CPC F17C 1/06; F17C 2201/0147; F17C 2203/012; F17C 2203/0619; F17C 2203/0624; F17C 2203/0673; F17C 2221/012; F17C 2270/0168; F17C 2270/0184

(57) ABSTRACT

A pressure vessel for fluid includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series, and a reinforcing layer covering outer peripheral walls of the main body portions and outer peripheral walls of the one or more bent portions, and including carbon fiber. A content of the carbon fiber per unit length in an extension direction of the reinforcing layer in the bent portion is less than a content of the carbon fiber per unit length in an extension direction of the reinforcing layer in the main body portion.

### CROSS-REFERENCE TO RELATED APPLICATION

This application claims priority to Japanese Patent Application No. 2024-176680 filed on Oct. 8, 2024. The disclosure of the above-identified application, including the specification, drawings, and claims, is incorporated by reference herein in its entirety.

### BACKGROUND

### 1. Technical Field

The technique disclosed in the present specification relates to a pressure vessel.

### 2. Description of Related Art

Japanese Unexamined Patent Application Publication (Translation of PCT Application) No. 2018-519480 (JP 2018-519480 A) discloses a pressure vessel for fluid. The pressure vessel includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series.

### SUMMARY

In the pressure vessel of JP 2018-519480 A, the bent portion is provided by bending a linear tubular portion. In order to increase the strength of the pressure vessel filled with fluid, a configuration in which the outer peripheral walls of the main body portions and the outer peripheral walls of the one or more bent portions are covered with a reinforcing layer is considered. However, the reinforcing layer covering the outer peripheral wall of the portion of the linear tubular portion that corresponds to the bent portion makes that portion difficult to bend.

The present specification provides a technique that is able to increase the strength of a pressure vessel and easily provide a bent portion of the pressure vessel.

In a first aspect, the present disclosure embodies a pressure vessel for fluid. The pressure vessel includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series, and a reinforcing layer covering outer peripheral walls of the main body portions and outer peripheral walls of the one or more bent portions, and including carbon fiber. A content of the carbon fiber per unit length in an extension direction of the reinforcing layer in the bent portion is less than a content of the carbon fiber per unit length in an extension direction of the reinforcing layer in the main body portion.

According to the above configuration, the portion of the linear tubular portion corresponding to the bent portion can be easily bent, compared to a configuration in which the content of the carbon fiber per unit length in the extension direction of the reinforcing layer in the bent portion is the same as the content of the carbon fiber per unit length in the extension direction of the reinforcing layer in the main body portion. Therefore, the strength of the pressure vessel is able to be increased, and the bent portion of the pressure vessel is able to be easily provided.

In a second aspect, in the first aspect, a content of the carbon fiber per unit volume of the reinforcing layer in the bent portion may be equal to a content of the carbon fiber per unit volume of the reinforcing layer in the main body portion. A thickness of the reinforcing layer in the bent portion may be thinner than a thickness of the reinforcing layer in the main body portion.

According to the above configuration, the reinforcing layer is able to be easily provided compared to a configuration in which the content of the carbon fiber per unit volume of the reinforcing layer in the bent portion and the content of the carbon fiber per unit volume of the reinforcing layer in the main body portion are different.

In a third aspect, in the second aspect, the reinforcing layer may be a laminated structure of carbon fiber layers at least in the main body portions, and the number of the carbon fiber layers in the bent portion may be smaller than the number of the carbon fiber layers in the main body portion.

According to the above configuration, the strength of the pressure vessel is able to be increased, and the bent portion of the pressure vessel is able to be easily provided.

In a fourth aspect, in the first aspect, a content of the carbon fiber per unit volume of the reinforcing layer in the bent portion may be less than a content of the carbon fiber per unit volume of the reinforcing layer in the main body portion.

According to the above configuration, the strength of the pressure vessel is able to be increased, and the bent portion of the pressure vessel is able to be easily provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a pressure vessel 2;

FIG. 2 is an enlarged view of portion II in FIG. 1;

FIG. 3 is a view showing a tubular member 102 before carbon fiber is wrapped thereon;

FIG. 4 is a view showing a method of winding the carbon fiber around the tubular member 102; and

FIG. 5 is an enlarged view of a pressure vessel 202 according to a second embodiment.

### DETAILED DESCRIPTION OF EMBODIMENTS

### First Embodiment

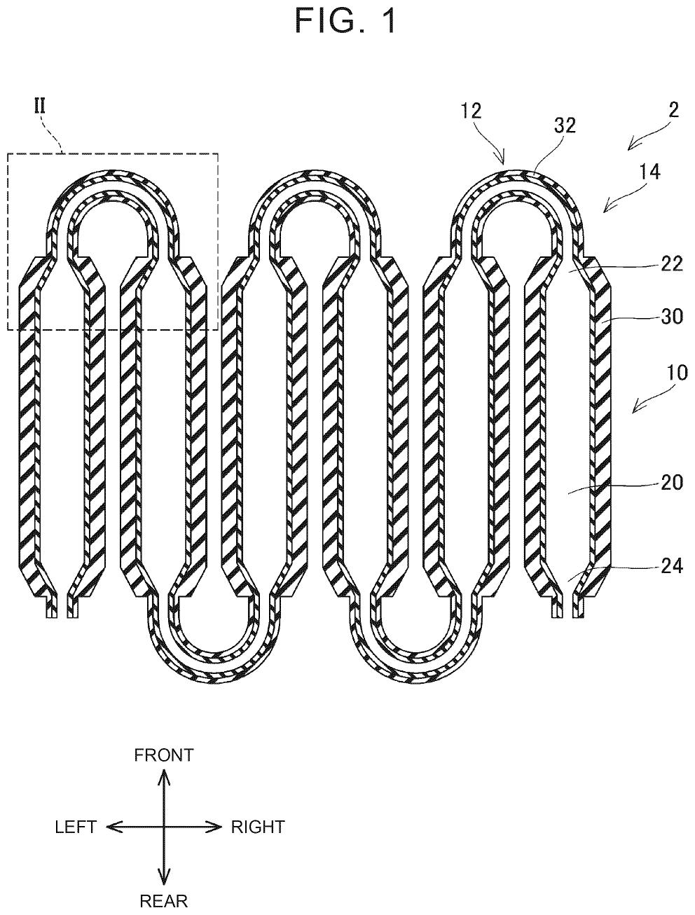

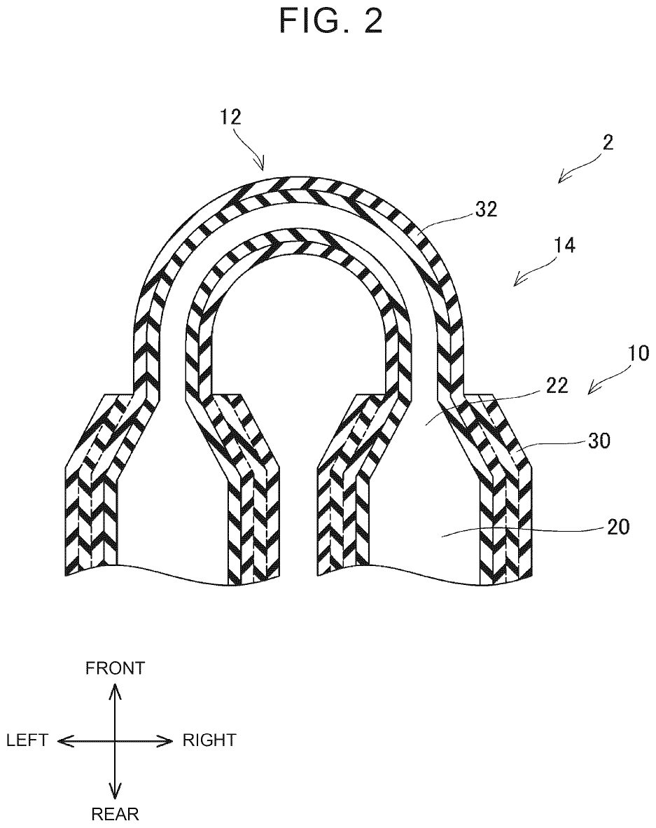

A pressure vessel 2 for fluid will be described with reference to FIGS. 1 and 2. As an example, the pressure vessel 2 is mounted on a fuel cell electric vehicle (not shown). The pressure vessel 2 is filled with high-pressure hydrogen gas that is used to generate electricity in the fuel cell electric vehicle.

As shown in FIG. 1, the pressure vessel 2 includes a plurality of main body portions 10, a plurality of bent portions 12, and a reinforcing layer 14. For convenience, in the following description, the direction in which the main body portions 10 are lined up will be referred to as the “left-right direction”, and the longitudinal direction of the main body portions 10, that is, the direction orthogonal to the left-right direction, will be referred to as the “front-rear direction”.

Each of the main body portions 10 extends along the front-rear direction. Each of the main body portions 10 has a tubular shape. The main body portion 10 includes a first cylindrical portion 20, a first truncated cone portion 22, and a second truncated cone portion 24. The first cylindrical portion 20 extends parallel to the front-rear direction. The first cylindrical portion 20 has a cylindrical shape. The first truncated cone portion 22 is connected to the front end portion of the first cylindrical portion 20. The first truncated cone portion 22 has a truncated cone shape. The first truncated cone portion 22 is inclined so that its outer diameter and inner diameter become smaller toward the front side. The second truncated cone portion 24 is connected to the rear end portion of the first cylindrical portion 20. The second truncated cone portion 24 has a truncated cone shape. The second truncated cone portion 24 is inclined so that its outer diameter and inner diameter become smaller toward the rear side.

Each of the bent portions 12 has a cylindrical shape. Each of the bent portions 12 is provided with a circular section perpendicular to the extension direction. Among the bent portions 12, each bent portion 12 located on the front side of the pressure vessel 2 extends between the front end portions of two adjacent main body portions 10 among the main body portions 10. For example, the rightmost bent portion 12 on the front side of the pressure vessel 2 extends forward from the front end portion of the rightmost main body portion 10, then bends and extends to the left, and bends further to extend to the front end portion of the adjacent main body portion 10.

Among the bent portions 12, each bent portion 12 located on the rear side of the pressure vessel 2 extends between the rear end portions of two adjacent main body portions 10 among the main body portions 10. For example, the rightmost bent portion 12 on the rear side of the pressure vessel 2 extends rearward from the rear end portion of the second main body portion 10 from the right, then bends and extends to the left, and bends further to extend to the rear end portion of the adjacent main body portion 10. The flow path axis of the bent portion 12 in FIG. 1 has a semicircular arc shape.

The bent portion 12 is connected to the front end portion of the main body portion 10 located on the rightmost side and the front end portion of the main body portion 10 located on the leftmost side, and the bent portion 12 is connected to both of the front and rear end portions of other main body portions 10. In this manner, the main body portions 10 are connected in series by the bent portions 12.

The reinforcing layer 14 includes a main body portion reinforcing layer 30 that covers the outer peripheral wall of the main body portion 10, and a bent portion reinforcing layer 32 that covers the outer peripheral wall of the bent portion 12. The main body portion reinforcing layer 30 and the bent portion reinforcing layer 32 are made of a resin containing carbon fiber. As an example, the main body portion reinforcing layer 30 and the bent portion reinforcing layer 32 are made of CFRP. The content of the carbon fiber per unit volume in the extension direction of the bent portion reinforcing layer 32 is equal to the content of the carbon fiber per unit volume in the extension direction of the main body portion reinforcing layer 30. That is, first density of the carbon fiber in the bent portion reinforcing layer 32 is equal to second density of the carbon fiber in the main body portion reinforcing layer 30. As shown in FIG. 2, the main body portion reinforcing layer 30 is a laminated structure of carbon fiber layers. The main body portion reinforcing layer 30 is made up by laminating three carbon fiber layers. The bent portion reinforcing layer 32 is a single-layer structure of a carbon fiber layer. Therefore, the content of the carbon fiber per unit length in the extension direction of the bent portion reinforcing layer 32 is less than the content of the carbon fiber per unit length in the extension direction of the main body portion reinforcing layer 30. Further, the thickness of the bent portion reinforcing layer 32 is thinner than the thickness of the main body portion reinforcing layer 30. Furthermore, the carbon fiber weight per unit length in the extension direction of the bent portion reinforcing layer 32 is lighter than the carbon fiber weight per unit length in the extension direction of the main body portion reinforcing layer 30.

### Manufacturing Method of Pressure Vessel 2

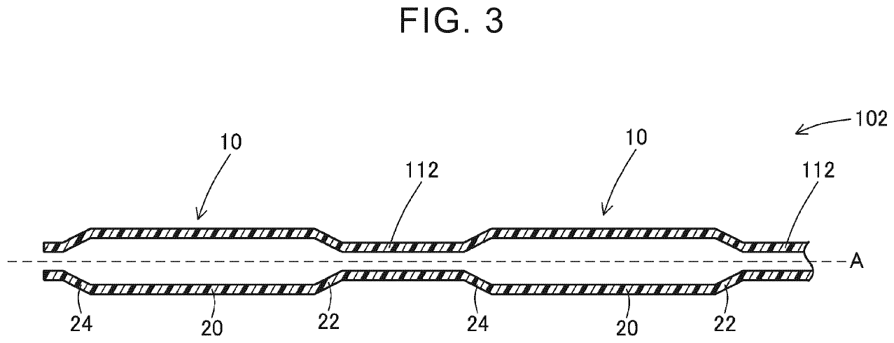

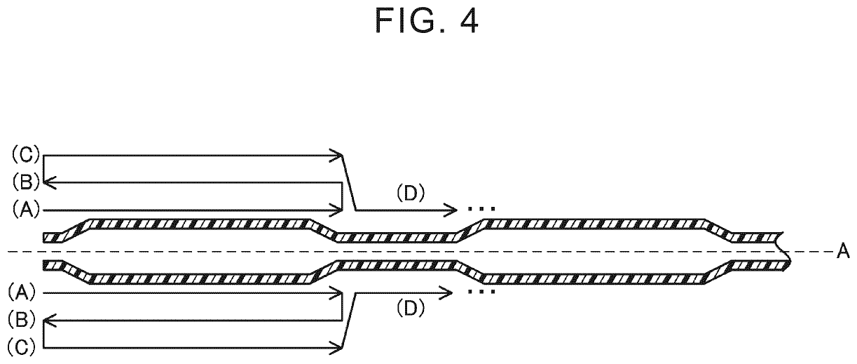

A manufacturing method of the pressure vessel 2 will be described with reference to FIGS. 3 and 4.

First, as shown in FIG. 3, a tubular member 102 is provided along an axis A direction. As an example, the tubular member 102 is integrally provided by extrusion molding. The tubular member 102 includes a plurality of main body portions 10 and a plurality of second cylindrical portions 112.

Next, as shown in FIG. 4, thread-like carbon fiber is wound around the outer peripheral walls of the main body portions 10 and the outer peripheral walls of the second cylindrical portions 112. As an example, the carbon fiber is wound in a spiral manner. First, the carbon fiber is wound from the left end portion to the right end portion of the main body portion 10 on the left side of FIG. 4 ((A) of FIG. 4). Next, the carbon fiber is wound from the right end portion to the left end portion of the main body portion 10 ((B) of FIG. 4). Next, the carbon fiber is wound from the left end portion to the right end portion of the main body portion 10 ((C) of FIG. 4). As a result, three carbon fiber layers are provided on the outer peripheral wall of a first main body portion 10A. Next, the carbon fiber is wound from the left end portion to the right end portion of the second cylindrical portion 112 ((D) of FIG. 4). As a result, a single carbon fiber layer is provided on the outer peripheral wall of the second cylindrical portion 112. Thereafter, (A) to (D) of FIG. 4 are repeated to provide three carbon fiber layers on the outer peripheral walls of the main body portions 10, and a single carbon fiber layer on the outer peripheral walls of the second cylindrical portions 112.

Next, the second cylindrical portions 112 are bent to provide the bent portions 12 (see FIG. 1). In this manner, the pressure vessel 2 shown in FIG. 1 is manufactured.

As described above, the bent portion 12 (see FIG. 1) is provided by bending the second cylindrical portion 112. However, when three carbon fiber layers similar to those on the outer peripheral wall of the main body portion 10 are provided on the outer peripheral wall of the second cylindrical portion 112, a relatively large force would be required to bend the second cylindrical portion 112. For this reason, it is desirable for the second cylindrical portion 112 to be provided with a configuration that is easy to bend. Therefore, the second cylindrical portion 112 is provided with a single carbon fiber layer. This makes it easier to bend the second cylindrical portion 112 compared to a configuration in which the outer peripheral wall of the second cylindrical portion 112 is provided with three carbon fiber layers similar to those of the outer peripheral wall of the main body portion 10.

### Effects of Embodiment

As described above, the pressure vessel 2 includes the main body portions 10, each having a tubular shape extending along the front-rear direction (an example of the “first direction”) and disposed along the left-right direction (an example of the “second direction”), the bent portions 12, each having a tubular shape, extending between two adjacent end portions of the main body portions 10, and connecting the main body portions 10 in series, and the reinforcing layer 14 that covers the outer peripheral walls of the main body portions 10 and the outer peripheral walls of the bent portions 12 and contains the carbon fiber. The content of the carbon fiber per unit length in the extension direction of the reinforcing layer 14 in the bent portion 12 is less than the content of the carbon fiber per unit length in the extension direction of the reinforcing layer 14 in the main body portion 10.

According to the above configuration, the portion of the linear tubular portion corresponding to the bent portion 12 can be easily bent, compared to a configuration in which the content of the carbon fiber per unit length in the extension direction of the reinforcing layer 14 in the bent portion 12 is the same as the content of the carbon fiber per unit length in the extension direction of the reinforcing layer 14 in the main body portion 10. Therefore, the strength of the pressure vessel 2 is able to be increased, and the bent portion 12 of the pressure vessel 2 is able to be easily provided.

Further, the content of the carbon fiber per unit volume of the reinforcing layer 14 in the bent portion 12 is equal to the content of the carbon fiber per unit volume of the reinforcing layer 14 in the main body portion 10. The thickness of the reinforcing layer 14 in the bent portion 12 is thinner than the thickness of the reinforcing layer 14 in the main body portion 10.

According to the above configuration, the reinforcing layer 14 is able to be easily provided compared to a configuration in which the content of the carbon fiber per unit volume of the reinforcing layer 14 in the bent portion 12 and the content of the carbon fiber per unit volume of the reinforcing layer 14 in the main body portion 10 are different.

Furthermore, the reinforcing layer 14 is a laminated structure of carbon fiber layers at least in the main body portions 10, and the number of the carbon fiber layers in the bent portion 12 is smaller than the number of the carbon fiber layers in the main body portions 10.

According to the above configuration, the strength of the pressure vessel 2 is able to be increased, and the bent portion 12 of the pressure vessel 2 is able to be easily provided.

### Second Embodiment

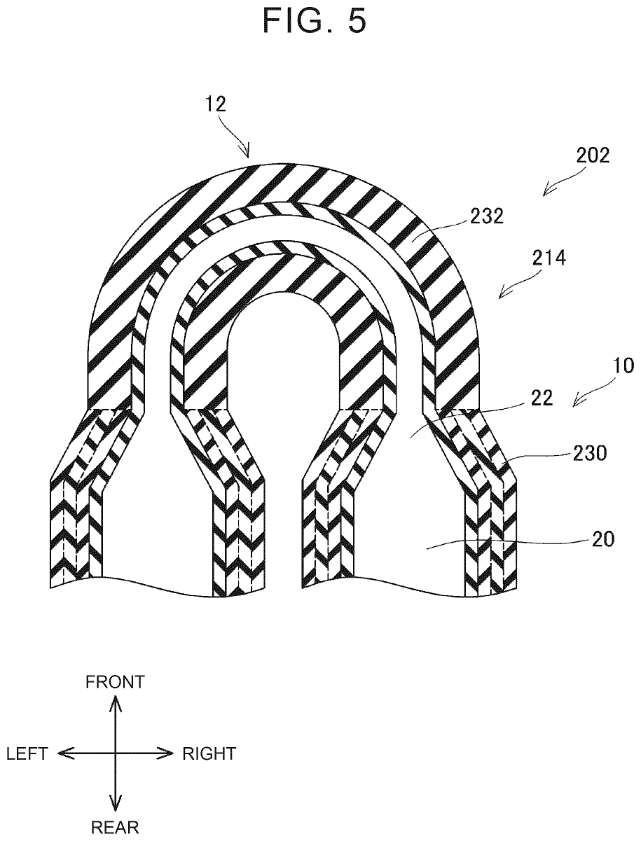

A pressure vessel 202 in a second embodiment will be described with reference to FIG. 5. In the pressure vessel 202 of the present embodiment, the configuration of a reinforcing layer 214 is different from the configuration of the reinforcing layer 14 of the pressure vessel 2 of the first embodiment.

The reinforcing layer 214 includes a main body portion reinforcing layer 230 that covers the outer peripheral wall of the main body portion 10, and a bent portion reinforcing layer 232 that covers the outer peripheral wall of the bent portion 12. The content of the carbon fiber per unit volume in the extension direction of the bent portion reinforcing layer 232 is less than the content of the carbon fiber per unit volume in the extension direction of the main body portion reinforcing layer 230. That is, the density of the carbon fiber in the bent portion reinforcing layer 232 is lower than the density of the carbon fiber in the main body portion reinforcing layer 230. The main body portion reinforcing layer 230 is a laminated structure of a carbon fiber layer. The bent portion reinforcing layer 232 is a single-layer structure of a carbon fiber layer. The thickness of the bent portion reinforcing layer 232 is equal to the thickness of the main body portion reinforcing layer 230. The content of the carbon fiber per unit length in the extension direction of the bent portion reinforcing layer 232 is less than the content of the carbon fiber per unit length in the extension direction of the main body portion reinforcing layer 230. Further, the content of the carbon fiber per unit length in the extension direction of the bent portion reinforcing layer 232 is less than the content of the carbon fiber per unit length in the extension direction of the main body portion reinforcing layer 230. Furthermore, the carbon fiber weight per unit length in the extension direction of the bent portion reinforcing layer 232 is lighter than the carbon fiber weight per unit length in the extension direction of the main body portion reinforcing layer 230. In a modification, when the content of the carbon fiber per unit length in the extension direction of the bent portion reinforcing layer 232 is less than the content of the carbon fiber per unit length in the extension direction of the main body portion reinforcing layer 230, the thickness of the bent portion reinforcing layer 232 may be thicker than the thickness of the main body portion reinforcing layer 230.

As described above, the content of the carbon fiber per unit volume in the reinforcing layer 214 in the bent portion 12 is less than the content of the carbon fiber per unit volume in the reinforcing layer 214 in the main body portion 10.

According to the above configuration, the strength of the pressure vessel 2 is able to be increased, and the bent portion 12 of the pressure vessel 2 is able to be easily provided.

Although the embodiments have been described in detail above, these are merely examples and do not limit the scope of the claims. The technique described in the claims includes various modifications and variations of the specific examples exemplified above.

### First Modification

The number of the main body portions 10 lined up in the left-right direction may be two to five, or may be seven or more.

### Second Modification

The cross-sectional shape perpendicular to the extension direction of the main body portion 10 and the sectional shape perpendicular to the extension direction of the bent portion 12 are not limited to a circular shape, and may be an elliptical shape, an oval shape, a quadrilateral shape, or the like.

### Third Modification

In the first and second embodiments, the bent portion reinforcing layers 32, 232 may be a laminated structure of carbon fiber layers.

### Fourth Modification

In the first and second embodiments, the carbon fiber may be wound by braiding.

### Fifth Modification

In the first and second embodiments, the bent portion reinforcing layers 32, 232 at the end portions in the extension direction of the bent portion 12 may be provided with the same configuration as the main body portion reinforcing layers 30, 230.

The technical elements described in the present specification or in the drawings exhibit technical usefulness alone or in various combinations, and are not limited to the combinations described in the claims at the time of filing the application. In addition, the technique exemplified in the present specification or drawings can achieve a plurality of purposes at the same time, and achieving one of the purposes itself has technical usefulness.

What is claimed is:

1. A pressure vessel for fluid, the pressure vessel comprising:
a plurality of main body portions, each having a tubular shape extending along a first direction and disposed along a second direction orthogonal to the first direction;
one or more bent portions, each having a tubular shape, extending between two adjacent end portions of the main body portions, and connecting the main body portions in series; and
a reinforcing layer covering outer peripheral walls of the main body portions and outer peripheral walls of the one or more bent portions, and including carbon fiber; wherein
a content of the carbon fiber per unit length in an extension direction of the reinforcing layer in the bent portion is less than a content of the carbon fiber per unit length in an extension direction of the reinforcing layer in the main body portion.

2. The pressure vessel according to claim 1, wherein:
a content of the carbon fiber per unit volume of the reinforcing layer in the bent portion is equal to a content of the carbon fiber per unit volume of the reinforcing layer in the main body portion; and
a thickness of the reinforcing layer in the bent portion is thinner than a thickness of the reinforcing layer in the main body portion.

3. The pressure vessel according to claim 2, wherein:
the reinforcing layer is a laminated structure of carbon fiber layers at least in the main body portions; and
the number of the carbon fiber layers in the bent portion is smaller than the number of the carbon fiber layers in the main body portion.

4. The pressure vessel according to claim 1, wherein a content of the carbon fiber per unit volume of the reinforcing layer in the bent portion is less than a content of the carbon fiber per unit volume of the reinforcing layer in the main body portion.
